(19) United States
(12) Patent Application Publication
(10) Pub. No.: US 2008/0136804 A1
(43) Pub. Date: Jun. 12, 2008

(54) LIQUID CRYSTAL DISPLAY

(76) Inventor: Hyun LEE, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/955,255

(22) Filed: Dec. 12, 2007

(30) Foreign Application Priority Data
Dec. 12, 2006 (KR) 10-2006-0126073

(51) Int. Cl. G06F 3/038; G09G 3/36

(52) U.S. Cl. 345/211; 345/96

(57) ABSTRACT

A liquid crystal display includes a pixel, a data line that transmits a data voltage to the pixel, a common voltage line that transmits a common voltage to the pixel, and a driver that selectively applies the data voltage and a ground voltage to the data line and selectively applies the common voltage and the ground voltage to the common voltage line.

### CROSS-REFERENCE TO RELATED APPLICATION

This application claims priority to and the benefit of Korean Patent Application No. 10-2006-00126073 filed in the Korean Intellectual Property Office on Dec. 12, 2006, the entire contents of which are incorporated herein by reference.

### BACKGROUND OF THE INVENTION

1. Field of the Invention

The present invention relates to a liquid crystal display.

2. Description of the Related Art

A liquid crystal display (LCD) is one of the most widely used flat panel displays. The LCD includes two display panels each having field-generating electrodes such as pixel electrodes and a common electrode, and a liquid crystal (LC) layer interposed between the electrodes. An electric field is induced in the LC layer by applying a voltage to the field-generating electrodes that determines the alignment of the LC molecules and controls the polarization of incident light to display an image. The LCD also includes switching elements connected to the pixel electrodes and a plurality of signal lines such as gate lines and data lines in order to supply data voltages to the pixel electrodes.

In order to prevent image deterioration due to long-time application of a unidirectional electric field to the LC layer, the polarity of the data voltages with respect to the common voltage is reversed every frame, every row, or every pixel, or the polarities of the common voltage and the data voltages are reversed.

When the polarity of the data voltage or the common voltage is reversed, the variation of the data voltage and the common voltage is large and causes power consumption to increase.

### SUMMARY OF THE INVENTION

An exemplary embodiment provides a liquid crystal display that employs a charge sharing section to reduce power consumption includes a pixel, a data line that transmits a data voltage to the pixel, a common voltage line that transmits a common voltage to the pixel, and a driver that selectively applies the data voltage and a ground voltage to the data line, and selectively applies the common voltage and the ground voltage to the common voltage line.

The driver may include a first switching element that is connected to the data voltage and the data line, a second switching element that is connected to the data line and the ground voltage, a third switching element that is connected to the common voltage and the common voltage line, and a fourth switching element that is connected to the common voltage line and the ground voltage.

The data voltage may be reversed by row inversion.

The common voltage may be reversed by row inversion.

The common voltage and the data voltage may have opposite polarities from each other with respect to the ground voltage.

The first switching element and the third switching element may be simultaneously turned on, and the second switching element and the fourth switching element may be simultaneously turned on.

A first turned-on section of the first switching element and the third switching element and a second turned-on section of the second switching element and the fourth switching element may be alternately repeated.

The polarities of the data voltage and the common voltage may be reversed after the second turned-on section.

The driver may include a driving voltage generator that generates a reference voltage and the common voltage, a gray voltage generator that generates gray voltages based on the reference voltage, and a data driver that selects one from the gray voltages to output as the data voltage.

The common voltage may include a first common voltage and a second common voltage having a different polarity from a polarity of the first common voltage with respect to the ground voltage, and absolute values of the first common voltage and the second common voltage may be substantially the same.

The reference voltage may include a first reference voltage and a second reference voltage having a different polarity from a polarity of the first reference voltage with respect to the ground voltage, and absolute values of the first reference voltage and the second reference voltage may be substantially the same.

The driver may be formed as one chip.

Another embodiment provides a liquid crystal display including a pixel, a data line that transmits a data voltage having a polarity row-reversed with respect to a ground voltage to the pixel, a common voltage line that transmits a common voltage having a polarity row-reversed with respect to the ground voltage to the pixel and having an opposite polarity to the data voltage, and a driver that selectively applies the data voltage and a ground voltage to the data line, and selectively applies the common voltage and the ground voltage to the common voltage line, wherein the data voltage and the common voltage are connected to the ground voltage before the polarity inversion.

The common voltage may include a first common voltage and a second common voltage having a different polarity from a polarity of the first common voltage with respect to the ground voltage, and absolute values of the first common voltage and the second common voltage may be substantially the same.

The driver may include a driving voltage generator that generates a reference voltage and the common voltage, a gray voltage generator that generates gray voltages based on the reference voltage, and a data driver that selects one from the gray voltages to output as the data voltage.

The reference voltage may include a first reference voltage and a second reference voltage having a different polarity from a polarity of the first reference voltage with respect to the ground voltage, and absolute values of the first reference voltage and the second reference voltage may be substantially the same.

### BRIEF DESCRIPTION OF THE DRAWINGS

An exemplary embodiment of the present invention will be described in detail with reference to the accompanying drawings, in which:

FIG. 1 is an exploded perspective view of an LCD according to an embodiment of the present invention.

FIG. 2 is a block diagram of an LCD according to an exemplary embodiment of the present invention.

FIG. 3 is an equivalent circuit diagram of a pixel of the LCD shown in FIG. 2.

FIG. 4 is a voltage waveform of a driving voltage generator of an LCD according to an exemplary embodiment of the present invention.

FIG. 5 is a block diagram of a data driver included in a driving chip of an LCD according to an exemplary embodiment of the present invention.

FIG. 6 shows a connection relationship between a driving chip 700 and an LC panel assembly 300 of an LCD according to an exemplary embodiment of the present invention.

FIG. 7A shows an example of waveforms of a data voltage, a common voltage, and a ground voltage used in an LCD according to an exemplary embodiment of the present invention.

FIG. 7B shows another example of waveforms of a data voltage, a common voltage, and a ground voltage used in an LCD according to an exemplary embodiment of the present invention.

FIG. 8 shows waveforms of a data voltage, a common voltage, and a ground voltage used in an LCD according to a prior art.

### DETAILED DESCRIPTION OF THE EMBODIMENTS

In the drawings, the thickness of layers, films, panels, regions, etc., are exaggerated for clarity. It will be understood that when an element such as a layer, film, region, or substrate is referred to as being “on” another element, it can be directly on the other element or intervening elements may also be present. In contrast, when an element is referred to as being “directly on” another element, there are no intervening elements present.

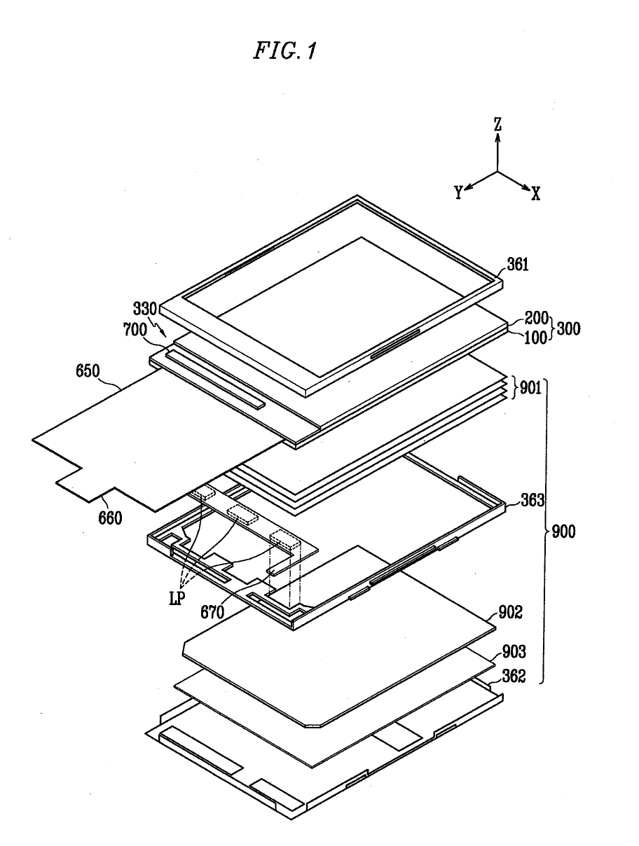

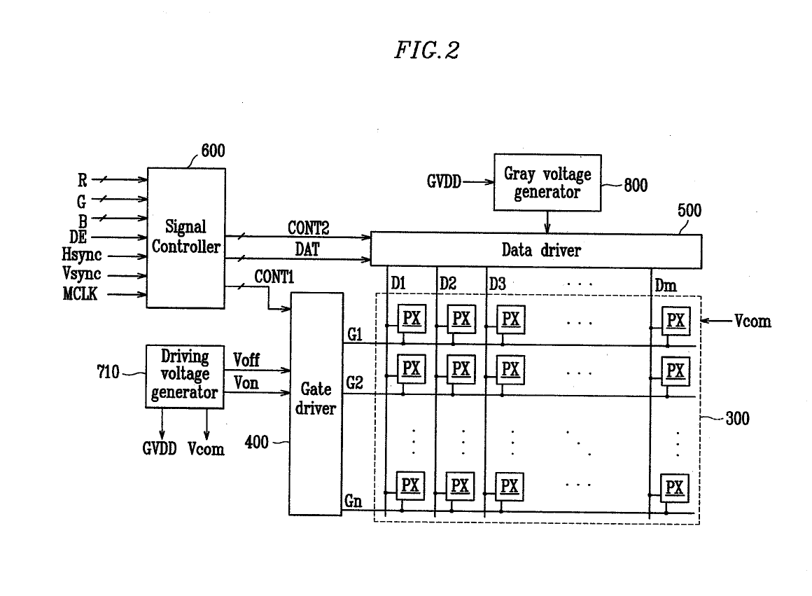

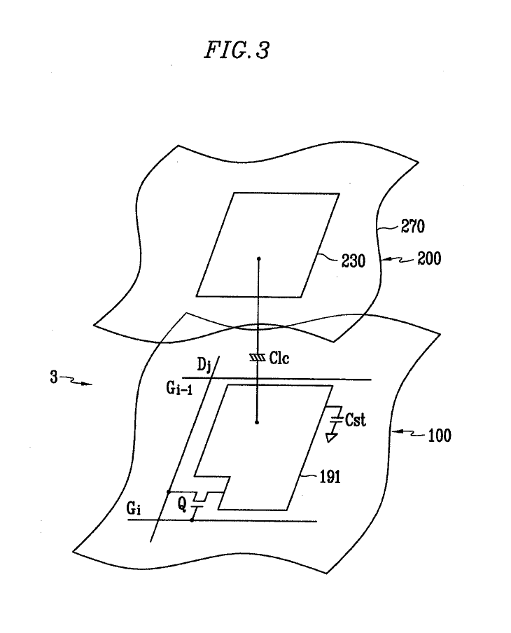

FIG. 1 is an exploded perspective view of an LCD according to an embodiment of the present invention, FIG. 2 is a block diagram of an LCD according to an exemplary embodiment of the present invention, and FIG. 3 is an equivalent circuit diagram of a pixel of the LCD shown in FIG. 2.

Referring to FIG. 1, an LCD according to an exemplary embodiment of the present invention includes an LC module having a display panel 330 and a backlight unit 900, front and rear chassis 361 and 362 containing the LC module, and a molded frame 363.

The display panel 330 includes a main LC panel assembly 300, a driving chip 700 mounted on the main LC panel assembly 300, and a flexible printed circuit board 650.

Referring to FIG. 1 and FIG. 2, the LC panel assembly 300 includes a plurality of signal lines G1-Gn and D1-Dm and a plurality of pixels PX. In the structural view shown in FIG. 2, the LC panel assembly 300 includes lower and upper panels 100 and 200 facing each other and an LC layer 3 interposed between the panels 100 and 200.

The signal lines include a plurality of gate lines G1-Gn transmitting gate signals (also referred to as “scanning signals” hereinafter), and a plurality of data lines D1-Dm transmitting data voltages. The gate lines G1-Gn extend substantially in a row direction and substantially parallel to each other, while the data lines D1-Dm extend substantially in a column direction and substantially parallel to each other.

The pixels PX are arranged substantially in a matrix. Referring to FIG. 2, each pixel PX, for example a pixel PX connected to an i-th gate line Gᵢ (i=1, 2, . . . , n) and a j-th data line Dⱼ (j=1, 2, . . . , m), includes a switching element Q connected to the signal lines Gᵢ and Dⱼ, and a LC capacitor Clc and a storage capacitor Cst that are connected to the switching element Q. The storage capacitor Cst may be omitted.

The switching element Q is disposed on the lower panel 100 and it has three terminals, i.e., a control terminal connected to the gate line Gᵢ, an input terminal connected to the data line Dⱼ, and an output terminal connected to the LC capacitor Clc and the storage capacitor Cst.

The LC capacitor Clc includes a pixel electrode 191 disposed on the lower panel 100 and a common electrode 270 disposed on the upper panel 200 as two terminals. The LC layer 3 disposed between the two electrodes 191 and 270 functions as a dielectric of the LC capacitor Clc. The pixel electrode 191 is connected to the switching element Q, and the common electrode 270 is supplied with a common voltage Vcom and covers an entire surface of the upper panel 200. Unlike in FIG. 3, the common electrode 270 may be provided on the lower panel 100, and at least one of the electrodes 191 and 270 may have a shape of a bar or a stripe.

The storage capacitor Cst is an auxiliary capacitor for the LC capacitor Clc. The storage capacitor Cst includes the pixel electrode 191 and a separate signal line (not shown) such as a storage electrode line, which is provided on the lower panel 100, overlaps the pixel electrode 191 via an insulator, and is supplied with a predetermined voltage such as the common voltage Vcom. Alternatively, the storage capacitor Cst includes the pixel electrode 191 and an adjacent gate line called a previous gate line, which overlaps the pixel electrode 191 via an insulator.

For color display, each pixel uniquely represents one of primary colors (i.e., spatial division) or each pixel sequentially represents the primary colors in turn (i.e., temporal division) such that a spatial or temporal sum of the primary colors is recognized as a desired color. An example of a set of the primary colors includes red, green, and blue colors. FIG. 2 shows an example of the spatial division in which each pixel includes a color filter 230 representing one of the primary colors in an area of the upper panel 200 facing the pixel electrode 191. Alternatively, the color filter 230 is provided on or under the pixel electrode 191 on the lower panel 100.

One or more polarizers (not shown) are attached to the panel assembly 300.

Referring to FIG. 1 and FIG. 2 again, the driving chip 700 includes a driving voltage generator 710, a gray voltage generator 800, a gate driver 400, a data driver 500, and a signal controller 600.

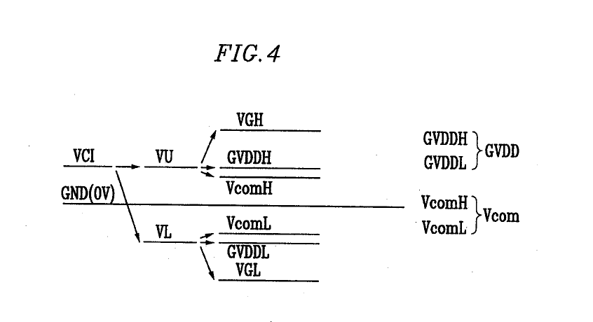

Referring to FIG. 4 as well as FIG. 1, the driving voltage generator 710 according to the embodiment of the present invention will be described in detail.

FIG. 4 shows a voltage waveform of a driving voltage generator of an LCD according to an exemplary embodiment of the present invention.

Referring to FIG. 4, the driving voltage generator 710 is supplied with a basic voltage VCI from a power supply (not shown) of an external device and boosts using the basic voltage VCI to generate voltages for driving the LCD. A level of the basic voltage VCI may be larger than that of a ground voltage GND.

The driving voltage generator 710 generates a first voltage VU and a second voltage VL based on the basic voltage VCI. At this time, the first voltage VU may have a level equal to that of the basic voltage VCI, and the second voltage VL may have a level lower than that of the ground voltage GND.

Then, the driving voltage generator 710 boosts in a positive direction (+) and a negative direction (−) using the first voltage VU, to generate third, fourth, and fifth voltages VGH, GVDDH, and VcomH. In addition, the driving voltage generator 710 boosts using the second voltage VD, to generate sixth, seventh, and eighth voltages VGL, GVDDL, and VcomL.

Here, the third and sixth voltages VGH and VGL are used as a gate-on voltage Von and a gate-off voltage Voff for turning-on and turning-off the switching element Q, respectively. The fourth and seventh voltages GVDDH and GVDDL function as the maximum value and the minimum value of a reference voltage GVDD, respectively. The fifth and eighth voltages VcomH and VcomL function as the maximum value and the minimum value of the common voltage Vcom that has a predetermined period, respectively.

At this time, pairs of the third and sixth voltages VGH and VGL, the fourth and seventh voltages GVDDH and GVDDL, and the fifth and eighth voltages VcomH and VcomL have a positive polarity (+) and a negative polarity (−) with respect to a ground voltage GND, respectively, and the absolute values of each pair are the same. In other words, the ground voltage GND has a middle magnitude of each pair of the third and sixth voltages VGH and VGL, the fourth and seventh voltages GVDDH and GVDDL, and the fifth and eighth voltages VcomH and VcomL.

Referring to FIG. 2 again, the gray voltage generator 800 generates a full number of gray voltages or a limited number of gray voltages (referred to as “reference gray voltages” hereinafter) related to the transmittance of the pixels PX, based on the reference voltage GVDD from the driving voltage generator 710. Some of the (reference) gray voltages have a positive polarity relative to the common voltage Vcom, while the other of the (reference) gray voltages have a negative polarity relative to the common voltage Vcom.

The gate driver 400 is connected to the gate lines G1-Gn of the panel assembly 300 and synthesizes a gate-on voltage Von and a gate-off voltage Voff to generate the gate signals for application to the gate lines G1-Gn.

The data driver 500 is connected to the data lines D1-Dm of the panel assembly 300 and applies data voltages, which are selected from the gray voltages supplied from the gray voltage generator 800, to the data lines D1-Dm. However, when the gray voltage generator 800 generates only a few of the reference gray voltages rather than all the gray voltages, the data driver 500 may divide the reference gray voltages to generate the data voltages from among the reference gray voltages.

The signal controller 600 controls the gate driver 400 and the data driver 500, etc.

At least one of the driving devices 400, 500, 600, 710, and 800 or at least one circuit element in at least one of the driving devices 400, 500, 600, and 800 may be disposed out of the single IC chip. Alternatively, each of driving devices 400, 500, 600, 710, and 800 may include at least one integrated circuit (IC) chip mounted on the LC panel assembly 300 or on a flexible printed circuit (FPC) film in a tape carrier package (TCP) type, which are attached to the panel assembly 300. Alternatively, at least one of the driving devices 400, 500, 600, 710, and 800 may be integrated into the panel assembly 300 along with the signal lines G1-Gn and D1-Dm and the switching elements Q.

Referring to FIG. 1, the FPC substrate 650 is attached near one side of the LC panel assembly 300. The FPC substrate 650 includes a projection 660 protruding toward an opposite direction with respect to the LC panel assembly 300. Signals from an external device are input through the projection 660, and the projection 660 and the driving chip 700 are connected to each other via the signal lines.

The FPC substrate 650 may include a passive device unit. The passive device unit may be connected to the driving voltage generator 710 of the driving chip 710 through voltage lines (not shown). The passive device unit may include a plurality of passive devices such as capacitors, inductors, and resistors, and the driving voltage generator 710 uses them to generate the driving voltages.

The molded frame 363 is positioned between the front chassis 361 and the rear chassis 362.

The backlight unit 900 includes lamps LP, circuit elements (not shown) to control the lamps LP, a PCB (printed circuit board) 670, a light guide plate 902, a reflective sheet 903, and a plurality of optical sheets 901.

The lamps LP are disposed on the PCB 670 positioned near an edge of a short side of the molded frame 363, and supply light toward the panel assembly 300.

The light guide plate 902 guides the light from the lamps LP toward the LC panel assembly 300 and uniformly maintains the intensity of the light.

The reflective sheet 903 is positioned under the light guide plate 902 and reflects the light from the lamps LP toward the LC panel assembly 300.

The optical sheets 901 are positioned over the light guide plate 902 and guarantee luminance characteristics of the light from the lamps LP.

The front chassis 361 and the rear chassis 362 are combined in the molded frame 363, and contain the LC module 310 therein.

Now, the operation of the above-described LCD will be described in detail.

The signal controller 600 is supplied with input image signals R, G, and B and input control signals for controlling the display thereof from an external graphics controller (not shown). The input image signals R, G, and B contain luminance information of pixels PX, and the luminance has a predetermined number of grays, for example 1024 (=2¹⁰), 256 (=2⁸), or 64 (=2⁶) grays. The input control signals include a vertical synchronization signal Vsync, a horizontal synchronization signal Hsync, a main clock signal MCLK, and a data enable signal DE.

On the basis of the input control signals and the input image signals R, G, and B, the signal controller 600 generates gate control signals CONT1 and data control signals CONT2 and it processes the image signals R, G, and B to be suitable for the operation of the panel assembly 300 and the data driver 500. The signal controller 600 sends the gate control signals CONT1 to the gate driver 400 and sends the processed image signals DAT and the data control signals CONT2 to the data driver 500.

The gate control signals CONT1 include a scanning start signal STV for instructing to start scanning and at least one clock signal for controlling the output period of the gate-on voltage Von. The gate control signals CONT1 may include an output enable signal OE for defining the duration of the gate-on voltage Von.

The data control signals CONT2 include a horizontal synchronization start signal STH for informing of start of data transmission for a row of pixels PX, a load signal LOAD for instructing to apply the data voltages to the data lines D1-Dm, and a data clock signal HCLK. The data control signal CONT2 may further include an inversion signal RVS for reversing the polarity of the data voltages (relative to the common voltage Vcom).

Responsive to the data control signals CONT2 from the signal controller 600, the data driver 500 receives a packet of the digital image signals DAT for the row of pixels PX from the signal controller 600, converts the digital image signals DAT into analog data voltages selected from the gray voltages, and applies the analog data voltages to the data lines D1-Dm.

The gate driver 400 applies the gate-on voltage Von to a gate line G1-Gn in response to the gate control signals CONT1 from the signal controller 600, thereby turning on the switching transistors Q connected thereto. The data voltages applied to the data lines D1-Dm are then supplied to the pixels PX through the activated switching transistors Q.

The difference between a data voltage and the common voltage Vcom applied to a pixel PX is represented as a voltage across the LC capacitor Clc of the pixel PX, which is referred to as a pixel voltage. The LC molecules in the LC capacitor Clc have orientations depending on the magnitude of the pixel voltage, and the molecular orientations determine the polarization of light passing through the LC layer 3. The polarizer(s) converts light polarization to the light transmittance such that the pixel PX has a luminance represented by a gray of the data voltage.

By repeating this procedure by a unit of a horizontal period (also referred to as “1H” and equal to one period of the horizontal synchronization signal Hsync and the data enable signal DE), all gate lines G1-Gn are sequentially supplied with the gate-on voltage Von, thereby applying the data voltages to all pixels PX to display an image for a frame.

When the next frame starts after one frame finishes, the inversion signal RVS applied to the data driver 500 is controlled such that the polarity of the data voltages is reversed (which is referred to as “frame inversion”). The inversion signal RVS may also be controlled such that the polarity of the data voltages flowing in a data line are periodically reversed during one frame (for example row inversion and dot inversion), or the polarity of the data voltages in one packet are reversed (for example column inversion and dot inversion).

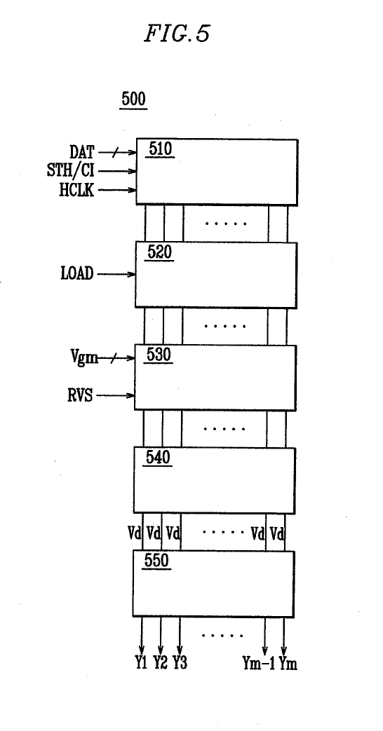

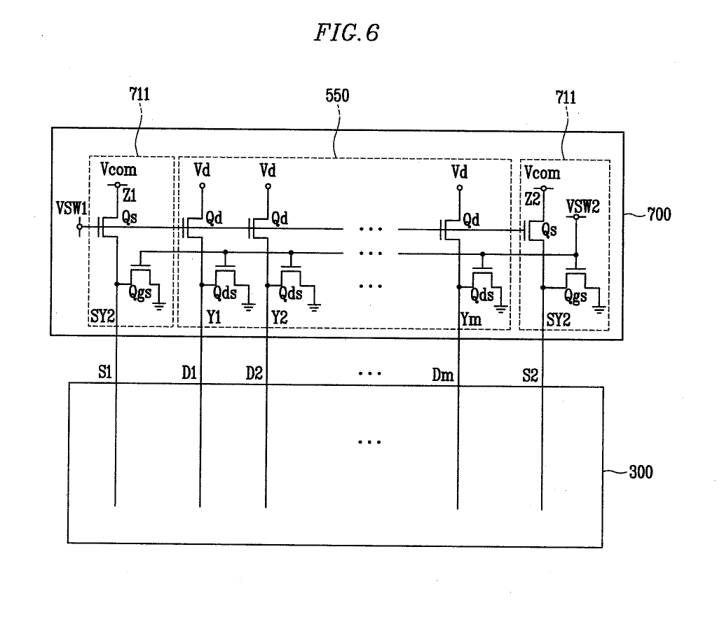

Referring to FIG. 5 and FIG. 6, operations of the driving chip of the LCD according to the embodiment of the present invention will be described in detail.

FIG. 5 is a block diagram of a data driver included in a driving chip of an LCD according to an exemplary embodiment of the present invention, and FIG. 6 shows a connection relationship between a driving chip and an LC panel assembly of an LCD according to an exemplary embodiment of the present invention.

Referring to FIG. 5, the data driver 500 includes a shift register 510, a latch 520, a digital-to-analog converter 530, a buffer 540, and a data line charging unit 550.

When the horizontal synchronization start signal STH or a shift clock signal Cl is input, the shift register 510 sequentially shifts the inputted image data DAT by synchronizing the data clock signal HCLK, to output to the latch 520.

The latch 520 outputs the analog image data DAT sequentially applied from the shift register 510 to the digital-to-analog converter 530 based on the load signal LOAD.

The digital-to-analog converter 530 is supplied with the gray voltages V_{gm} from the gray voltage generator 800, and selects gray voltages of a positive polarity or a negative polarity with respect to the common voltage Vcom based on the inversion signal RVS. Then, the digital-to-analog converter 530 selects gray voltages corresponding to digital image data DAT from the gray voltages of the positive polarity or the negative polarity to convert the digital image data DAT to analog data voltages Vd.

The buffer 540 outputs the data voltages Vd from the digital-to-analog converter 530 to the data line charging unit 550, and maintains the data voltages for about 1H.

The data line charging unit 550 has a plurality of output lines Y1-Ym connected to the corresponding data lines D1-Dm to apply the corresponding data voltages Vd to the data lines D1-Dm, respectively.

The data charging unit 550 includes a plurality of switching elements Qd and Qds.

The switching elements Qd and Qds are transistors of which each has an input terminal, a control terminal, and an output terminal.

That is, each of the switching elements Qd has the input terminal connected to the corresponding output terminal of the buffer 540, the control terminal connected to a control signal VSW1, and the output terminal connected to the corresponding output lines Y1-Ym.

Each of the switching elements Qds has the input terminal connected to a ground voltage, the control terminal connected to a control signal VSW2, and the output terminal connected to the corresponding output lines Y1-Ym.

The output lines Y1-Ym are connected to the data lines D1-Dm of the LC panel assembly 300. Referring to FIG. 6, the LC panel assembly 300 further includes common voltage lines S1 and S2 transmitting a common voltage Vcom. The common voltage lines S1 and S2 are positioned on both sides with respect to the data lines D1-Dm, respectively. The common voltage lines S1 and S2 may be connected to the storage electrode lines and the common electrode 270.

In the meantime, the driving voltage generator 710 includes a common voltage charging unit 711.

The common voltage charging unit 711 includes switching elements Qs and Qgs. The switching elements Qs and Qgs are also transistors of which each has an input terminal, a control terminal, and an output terminal.

In more detail, each of the switching elements Qs has the input terminal connected to a corresponding common voltage output line Z1 or Z2, the control terminal connected to the control signal VSW1, and the output terminal connected to the corresponding output line SY1 or SY2. The common voltage output line Z1 or Z2 is supplied with the common voltage Vcom.

Each of the switching elements Qgs has the input terminal connected to the ground voltage, the control terminal connected to the control signal VSW2, and the output terminal connected to the corresponding output line SY1 or SY2.

The output lines SY1 and SY2 are connected to the common voltage lines S1 and S2 of the LC panel assembly 300.

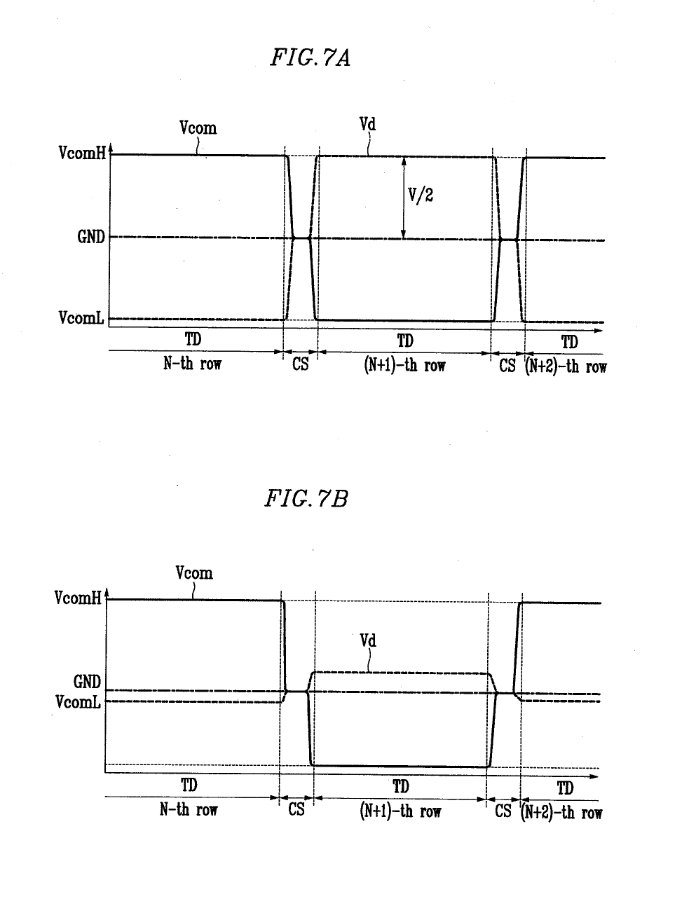

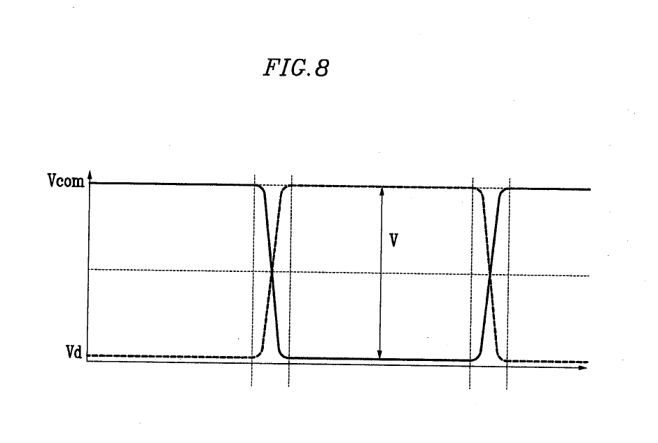

Referring to FIG. 7A, FIG. 7B, and FIG. 8 as well as FIG. 6, operations of the data charging unit and the common voltage charging unit according to the embodiment will be described.

FIG. 7A shows an example of waveforms of a data voltage, a common voltage, and a ground voltage used in an LCD according to an exemplary embodiment of the present invention, FIG. 7B shows another example of waveforms of a data voltage, a common voltage, and a ground voltage used in an LCD according to an exemplary embodiment of the present invention, and FIG. 8 shows waveforms of a data voltage, a common voltage, and a ground voltage used in an LCD according to a prior art.

In the embodiment, the polarities of the data voltage Vd and the common voltage Vcom are reversed with respect to the ground voltage GND every one row. That is, an inversion type of the LCD of the embodiment is the row inversion. The common voltage Vcom swings between the maximum value VcomH and the minimum value VcomL every row. The polarities of the data voltage Vd and the common voltage Vcom are opposite to each other with respect to the ground voltage GND.

Referring to FIG. 7A and FIG. 7B, in the voltage charging section TD, the control signal VSW1 has a high level, and the control signal VSW2 has a low level. Thereby, the switching elements Qd and Qs are turned on, and the switching elements Qgd and Qgs are turned-off.

Therefore, the data voltages Vd are applied to the output lines Y1-Ym through the turned-on switching elements Qd to transmit to the data lines D1-Dm, respectively. The common voltage Vcom applied from the driving voltage generator 710 is transmitted to the common voltage lines S1 and S2 through the turned-on switching elements Qs, respectively.

In the sharing section CS, the control signal VSW1 has the low level, and the control signal VSW2 has the high level. Thereby, the switching elements Qd and Qs are turned off, and the switching elements Qgd and Qgs are turned on. Therefore, the data lines D1-Dm and the common voltage lines S1 and S2 are connected to the ground voltage GND through the turned-on switching elements Qds and Qgs. That is, after the voltage charging section TD, voltage levels of the data lines D1-Dm and the common voltage lines S1 and S2 are changed to the ground voltage GND.

Thereby, as shown in FIG. 7A and FIG. 7B, in the voltage charging section TD, the data voltages Vd and the common voltage Vcom are transmitted to the data lines D1-Dm and the common voltage lines S1 and S2 in the voltage charging section TD, but in the sharing section CS, the levels of the data voltages Vd and the common voltage Vcom become the ground voltage GND, to be initialized by the ground voltage GND.

FIG. 7A shows the variation of the data voltage Vd and the common voltage Vcom when the data voltage Vd having the same level as the maximum value VcomH or the minimum value VcomL of the common voltage Vcom is applied to every pixel row, and FIG. 7B shows the variation of the data voltage Vd and the common voltage Vcom when the value of the data voltage Vd is varied every pixel row.

In the meantime, FIG. 8 shows the variations of the data voltage Vd and the common voltage Vcom according to a prior art in which the sharing sections CS do not exist.

As shown in FIG. 8, since the sharing sections CS are not existed, the variation V of the common voltage Vcom and the data voltage Vd increases when the polarities of the common voltage Vcom and the data voltage Vd are reversed every pixel row. Thereby, consumption power increases.

As shown in FIG. 7A and FIG. 7B, in the sharing section CS after the voltage charging section TD, the data voltage Vd and the common voltage Vcom maintain the ground voltage GND. Thereby, when the polarities of the data voltage Vd and the common voltage Vcom are reversed with respect to a previous pixel row, the variation of the data voltage Vd and the common voltage Vcom is reduced. For example, it is assumed that the magnitude differences between the data voltage Vd having a positive polarity and the data voltage Vd having a negative polarity and between the common voltage Vcom having a positive polarity and the common voltage Vcom having a negative polarity are about “V”, respectively. Since the data voltage Vd and the common voltage Vcom are changed from the ground voltage GND to the data voltage Vd and the common voltage Vcom of corresponding polarities, the variation of the data voltage Vd and the common voltage Vcom is about “½V”. Therefore, consumption power reduces.

Accordingly, the polarities of the common voltage and the data voltage are reversed with respect to the ground voltage, and the data voltage and the common voltage are connected to the ground voltage in the sharing section, and thereby a reduced amount of the consumption power is uniformly maintained, and the variation of the common voltage Vcom is uniform without the variation of the data voltage Vd to improve image quality.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a pixel;
a data line that transmits a data voltage to the pixel;
a common voltage line that transmits a common voltage to the pixel; and
a driver that selectively applies the data voltage and a ground voltage to the data line and selectively applies the common voltage and the ground voltage to the common voltage line.

2. The liquid crystal display of claim 1, wherein the driver comprises:
a first switching element that is connected to the data voltage and the data line;
a second switching element that is connected to the data line and the ground voltage;
a third switching element that is connected to the common voltage and the common voltage line; and
a fourth switching element that is connected to the common voltage line and the ground voltage.

3. The liquid crystal display of claim 1, wherein the data voltage is reversed by row inversion.

4. The liquid crystal display of claim 3, wherein the common voltage is reversed by row inversion.

5. The liquid crystal display of claim 4, wherein the common voltage and the data voltage have opposite polarities to each other with respect to the ground voltage.

6. The liquid crystal display of claim 5, wherein the first switching element and the third switching element are simultaneously turned on, and the second switching element and the fourth switching element are simultaneously turned on.

7. The liquid crystal display of claim 6, wherein a first turned-on section of the first switching element and the third switching element and a second turned-on section of the second switching element and the fourth switching element are alternately repeated.

8. The liquid crystal display of claim 7, wherein the polarities of the data voltage and the common voltage are reversed after the second turned-on section.

9. The liquid crystal display of claim 1, wherein the driver comprises:
a driving voltage generator that generates a reference voltage and the common voltage;
a gray voltage generator that generates gray voltages based on the reference voltage; and
a data driver that selects one from the gray voltages to output as the data voltage.

10. The liquid crystal display of claim 9, wherein the common voltage comprises a first common voltage and a second common voltage having a different polarity from a polarity of the first common voltage with respect to the ground voltage, and absolute values of the first common voltage and the second common voltage are substantially the same.

11. The liquid crystal display of claim 9, wherein the reference voltage comprises a first reference voltage and a second reference voltage having a different polarity from a polarity of the first reference voltage with respect to the ground voltage, and absolute values of the first reference voltage and the second reference voltage are substantially the same.

12. The liquid crystal display of claim 11, wherein the driver is formed as one chip.

13. A liquid crystal display comprising:
a pixel;
a data line that transmits a data voltage having a polarity row-reversed with respect to a ground voltage to the pixel;
a common voltage line that transmits a common voltage having a polarity row-reversed with respect to the ground voltage to the pixel and having an opposite polarity to the data voltage; and
a driver that selectively applies the data voltage and a ground voltage to the data line, and selectively applies the common voltage and the ground voltage to the common voltage line,
wherein the data voltage and the common voltage are connected to the ground voltage before the polarity inversion.

14. The liquid crystal display of claim 13, wherein the common voltage comprises a first common voltage and a second common voltage having a different polarity from a polarity of the first common voltage with respect to the ground voltage, and absolute values of the first common voltage and the second common voltage are substantially the same.

15. The liquid crystal display of claim 13, wherein the driver comprises:
a driving voltage generator that generates a reference voltage and the common voltage;
a gray voltage generator that generates gray voltages based on the reference voltage; and
a data driver that selects one from the gray voltages to output as the data voltage.

16. The liquid crystal display of claim 15, wherein the reference voltage comprises a first reference voltage and a second reference voltage having a different polarity from a polarity of the first reference voltage with respect to the ground voltage, and absolute values of the first reference voltage and the second reference voltage are substantially the same.
